(19) United States
(12) Patent Application Publication
(10) Pub. No.: US 2005/0252067 A1
(43) Pub. Date: Nov. 17, 2005

(54) Decoy holder

(76) Inventor: B. Eric Wade, Olathe, KS (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/120,748

(22) Filed: May 3, 2005

Related U.S. Application Data
(60) Provisional application No. 60/567,560, filed on May 3, 2004.

(51) Int. Cl. A01M 31/06

(52) U.S. Cl. 43/3

(57) ABSTRACT

A decoy holder is provided that releasably retains the keel of a keel-type floater decoy. The holder includes a central cavity in which the keel of a decoy can be inserted. The holder includes a generally flat base that supports the decoy in an upright position on solid ground.

This application claims priority pursuant to 35 U.S.C. 119(e) to co-pending U.S. Provisional Patent Application Ser. No. 60/567,560, filed May 3, 2004, the entire disclosure of which is incorporated herein by reference.

### FIELD OF THE INVENTION

The present invention relates generally to decoys. More particularly, it is concerned with a holder or stand for supporting floating decoys on a solid surface and methods of supporting keel-type decoys.

### BACKGROUND OF THE INVENTION

Animal decoys have been used for centuries for attracting various animals into the range of concealed hunters. The most recognized form of decoy is the duck or goose waterfowl decoy formed in three dimensions and painted to closely resemble the selected animal.

Waterfowl can be found, and therefore are hunted, in a variety of different habits, including both water (i.e. marshes, ponds, lakes, rivers, ponds, etc.) and land. Therefore, three-dimensional waterfowl decoys have been developed for both field and floating applications. In most instances, field and floating decoys are single purpose (i.e. floaters cannot be used in the field, and field decoys do not float). Therefore, people who hunt waterfowl over both land and water must purchase separate decoys for each terrain. This can be extremely expensive and consumes considerable storage space. In addition, hunters who use decoys on both land and water, or who vary their hunting location between land and water, during a single outing must endure the burden of hauling both floater and field decoys to their hunting sites.

One common form of three-dimensional waterfowl decoy for field hunting is a shell decoy. Shell decoys are formed of a thin plastic or other suitable material in the shape of the top half of a bird (i.e. duck or goose) body with the interior of the body being hollow and the exterior being painted to resemble the bird. The bottom of the shell is generally flat to allow placement of the shell on the ground in a manner that resembles a waterfowl lying on the ground, either resting or feeding. Another three-dimensional waterfowl decoy is a full body decoy, which includes a stand that is generally shaped to resemble the feet and legs of the bird.

Although some variations of shell decoys have been developed that float and can therefore be used for hunting over water, such decoys are not preferred by hunters because they are top heavy and therefore easily tip over in windy conditions. Therefore, preferred floater decoys include a keel (either weighted or hollow which fills with water) extending along the length of the bottom of the body. The keel provides stability to the decoy while floating, but also makes use of the decoy on land impractical. This is because the keel, which protrudes from the body, causes the decoy body the lay partially tipped over on the ground, resulting in an unrealistic appearance to the decoy. Therefore, it would be beneficial to provide a mechanism that permits realistic arrangement of decoys having keels on land.

### SUMMARY OF THE INVENTION

A principal object of the instant invention is to provide a holder for a keel-type decoy.

Another object of the instant invention is to provide a method of supporting a keel-type floater decoy on solid ground.

The objects of the instant invention are accomplished through the use of a holder or stand that releasably retains the keel of a keel-type floater decoy. The holder includes a central cavity in which the keel of a decoy can be inserted. The holder includes a generally flat base that supports the decoy in an upright position on solid ground.

In a preferred embodiment, the holder is constructed as a single unit including a central cavity including a cavity base member, two sidewalls protruding upward from the base member, a generally flat top member extending from the top of each sidewall, a leg extending downward from each top member, and a generally flat foot extending from each leg. The feet support the decoy for which the keel has been inserted in the cavity in a generally upright position. The top members help to support the generally flat base of the decoy body located on either side of the keel.

In a preferred embodiment the holder is manufactured of a 24 gauge pre-finished metal which provides for suitable elastic deformation of the side walls of the central cavity to allow the keel to be easily inserted and removed from the central cavity. In addition, the elasticity of the metal causes the sides of the cavity to clamp around the keel and prevent accidental removal of the keel from the holder. The holder is manufactured by sequentially bending a flat sheet of the metal. For a 20 inch wide piece of metal, a first 80 degree bend is made approximately ¾ inches away from an end of the sheet of metal to form a first foot. A second 80 degree bend, is made in the opposite direction of the first bend approximately 4 inches from the first bend to form a first leg. A third 100 degree bend is then made in the same direction as the second bend approximately 1 inch away from the second bend to form a first top member. A fourth 100 degree bend is then made in the opposite direction as the third bend approximately 3¼ inches from the third bend to form a first cavity sidewall. A fifth 100 degree bend is made in the same direction as the fourth bend approximately 2 inches from the fourth bend to form the cavity base. A sixth 100 degree bend is made in the opposite direction as the fifth bend approximately 3¼ inches from the fifth bend to form a second cavity sidewall. A seventh 80 degree bend is made in the same direction as the sixth bend approximately 1 inch from the sixth bend to form a second top member. A final eighth bend is made in the opposite direction as the seventh bend approximately 4 inches from the seventh bend to form the second leg and foot.

In operation, the decoys and inventive holders are carried in separate pieces, or alternatively assembled together, to a field or other desired hunting location by the hunter. If the hunter desires to use the decoys in water, the keels are removed from the grasp of the holders (if the holders and decoys are assembled together). If the hunting conditions change, such that the hunter desires to place the decoy on land, the keel is inserted into the cavity and the holder and decoy are placed in an upright position on the ground. In this manner, a single set of decoys can be used both as floaters and field decoys. The decoy holders take up significantly less storage space and are easier to carry than a second set of specially designed field decoys.

The same holder can be used for virtually all types of waterfowl decoys having a keel. In a preferred embodiment, a longer holder (i.e. 10 inches in length) is used for goose decoys than the holder for duck decoys (i.e. 6 inches in length). This is to accommodate the generally larger bodies (and therefore longer keels) for goose decoys as opposed to duck decoys.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION OF THE DRAWINGS

A preferred embodiment of the invention, illustrative of the best mode in which the applicant has contemplated applying the principles, is set forth in the following description and is shown in the drawings and is particularly and distinctly pointed out and set forth in the appended claims.

FIG. 1 is an isometric view of a preferred embodiment of the decoy holder of the instant invention.

FIG. 2 is an end elevation section view of the decoy holder of FIG. 1.

FIG. 3 is a sectional end elevation view of the decoy holder of FIG. 1.

FIG. 4 is an end elevation section view of the decoy holder of FIG. 1 with a decoy being supported by the holder.

### DETAILED DESCRIPTION OF A PREFERRED EMBODIMENT

As required, a detailed embodiment of the present inventions is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

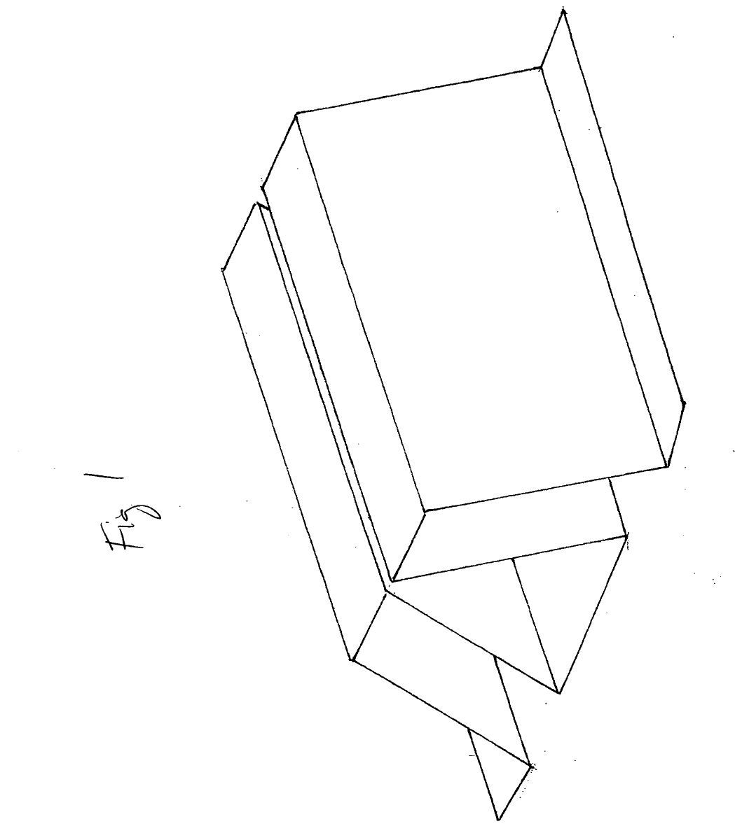

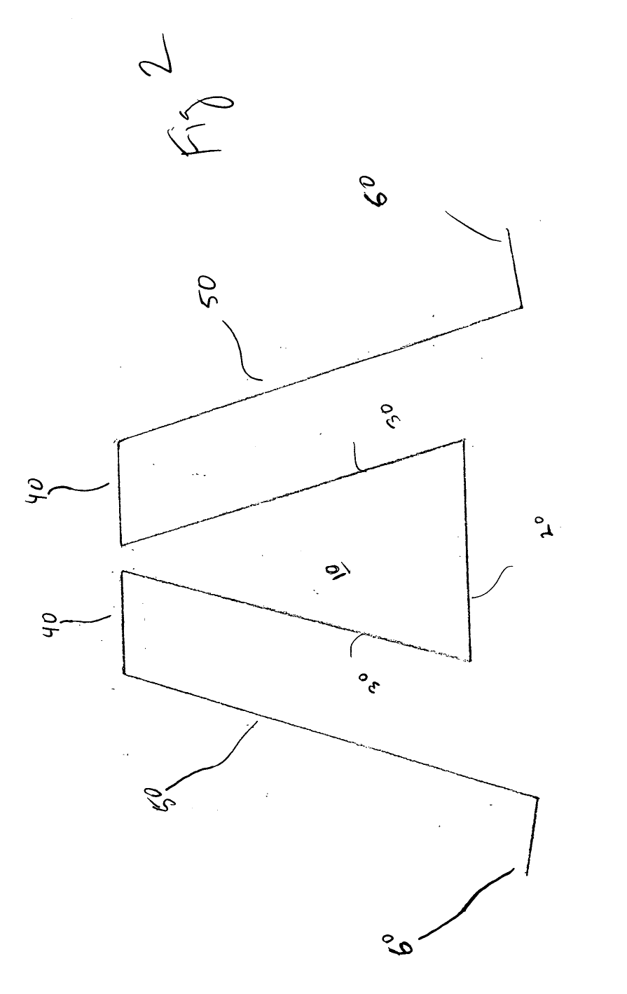

Referring to FIGS. 1-4, a preferred embodiment of the decoy holder of the instant invention is shown. In the preferred embodiment shown, the holder is constructed as a single unit including central cavity, 10, cavity base member 20, sidewalls 30 protruding upward from base member 20, generally flat top members 40 extending from the top of each sidewall 30, leg 50 extending downward from each top member 40, and generally flat feet 60 extending from each leg. Feet 60 support the decoy for which the keel has been inserted in cavity 10 in a generally upright position. Top members 40 help to support the generally flat base of the decoy body located on either side of the keel.

In a preferred embodiment the holder is manufactured of a 24 gauge pre-finished metal which provides for suitable elastic deformation of side walls 30 of central cavity 10 to allow keel 110 of decoy 100 to be easily inserted and removed from central cavity 10. In addition, the elasticity of the metal causes sides 30 of cavity 10 to clamp around keel 110 and prevent accidental removal of decoy 100 from the holder.

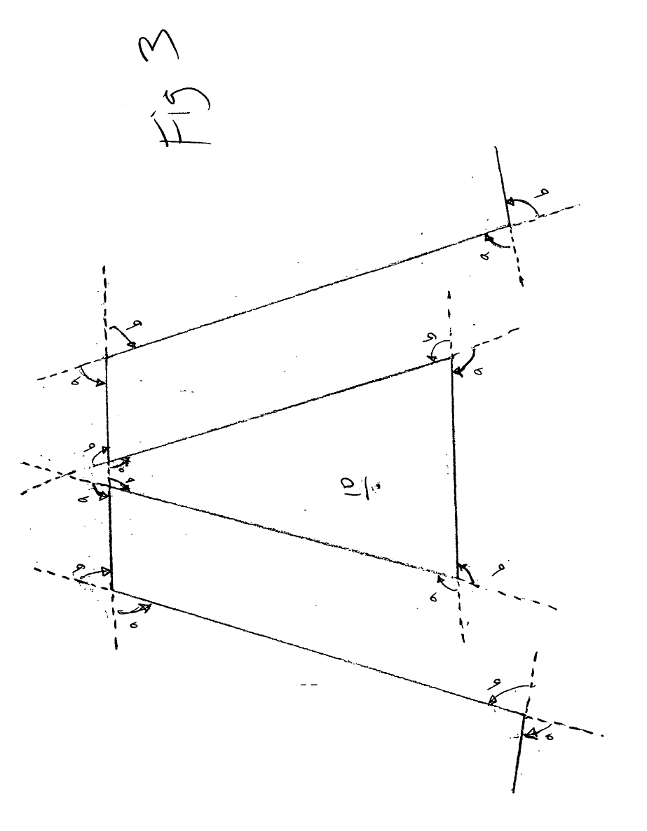

The holder is manufactured by sequentially bending a flat sheet of the metal. FIG. 3 shows the bend angles for manufacturing the holder from a single sheet of metal. In FIG. 3, angles “a” represent bends made in bending the sheet of metal starting from the right side of FIG. 3 to the left; and angles “b” represent bends made in bending the sheet of metal starting from the left side of FIG. 3 to the right. For a 20 inch wide piece of metal, a first 80 degree bend is made approximately ¾ inches away from an end of the sheet of metal to form a first foot 60. A second 80 degree bend, is made in the opposite direction of the first bend approximately 4 inches from the first bend to form a first leg 50. A third 100 degree bend is then made in the same direction as the second bend approximately 1 inch away from the second bend to form a first top member 40. A fourth 100 degree bend is then made in the opposite direction as the third bend approximately 3¼ inches from the third bend to form a first cavity sidewall 30. A fifth 100 degree bend is made in the same direction as the fourth bend approximately 2 inches from the fourth bend to form cavity base 20. A sixth 100 degree bend is made in the opposite direction as the fifth bend approximately 3¼ inches from the fifth bend to form a second cavity sidewall 30. A seventh 80 degree bend is made in the same direction as the sixth bend approximately 1 inch from the sixth bend to form a second top member 40. A final eighth bend is made in the opposite direction as the seventh bend approximately 4 inches from the seventh bend to form second leg 50 and foot 60.

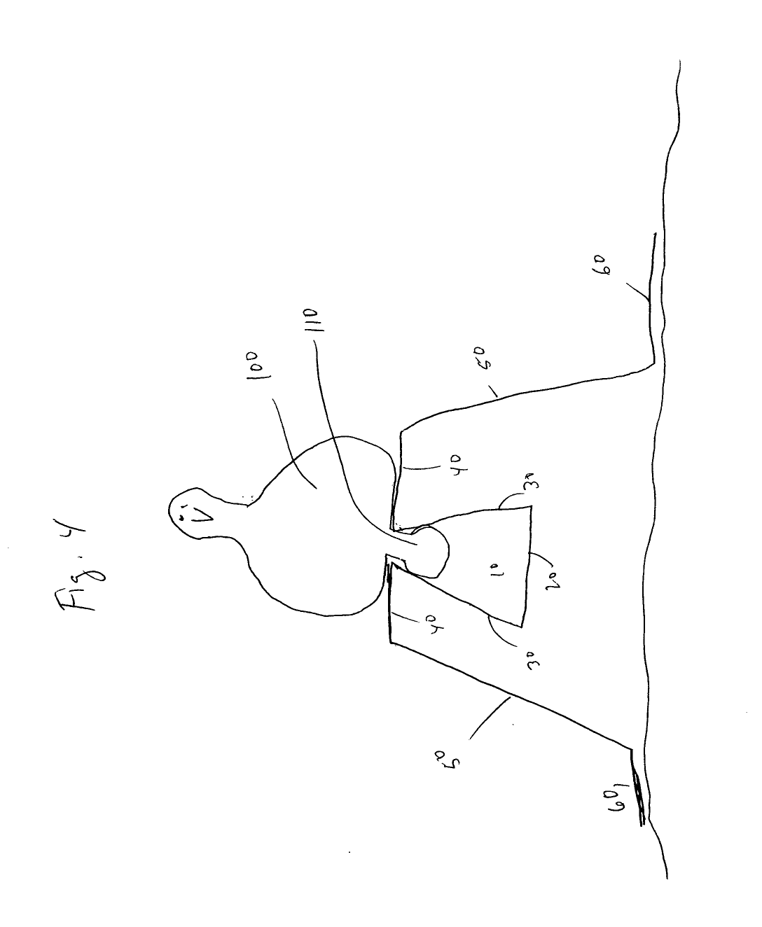

In operation, several decoys and inventive holders are carried in separate pieces, or alternatively assembled together, to a field or other desired hunting location by the hunter. If the hunter desires to use the decoys in water, the keels of the decoys are removed from the grasp of the holders (if the holders and decoys are assembled together). If the hunting conditions change, such that the hunter desires to place the decoy on land, keel 110 is inserted into cavity 10 and the holder and decoy 100 are placed in an upright position on the ground as shown in FIG. 4. In this manner, a single set of decoys can be used both as floaters and field decoys. The decoy holders take up significantly less storage space and are easier to carry than a second set of specially designed field decoys.

The same holder can be used for virtually all types of waterfowl decoys having a keel. In another preferred embodiment, a longer holder (i.e. 10 inches in length) is used for goose decoys than the holder for duck decoys (i.e. 6 inches in length). This is to accommodate the generally larger bodies (and therefore longer keels) for goose decoys as opposed to duck decoys.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall with in the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

1. A decoy holder comprising:
a cavity adapted to receive a decoy keel; and
a base associated with said cavity.

2. The decoy holder as claimed in claim 1 further comprising sidewalls associated with said cavity adapted to surround the decoy keel.

3. The decoy holder as claimed in claim 2 wherein said sidewalls are elastically deformable to clamp around the decoy keel.

4. The decoy holder as claimed in claim 1 further comprising a top member associated with said cavity adapted to support a body-base of the decoy.

5. The decoy holder as claimed in claim 1 wherein said base comprises a pair of generally flat feet members adapted to support said holder and the decoy in an upright position.

6. A decoy holder comprising:
a central cavity, said central cavity includes a cavity base member;
a pair of sidewalls protruding upward from opposing sides of said cavity base member;
a generally flat top member extending from a top of each of said sidewalls;
a leg member extending from each of said top members; and
a foot member extending from each of said legs.
